(19) United States
(12) Patent Application Publication
(10) Pub. No.: US 2026/0261508 A1
(43) Pub. Date: Sep. 3, 2026

(54) SEGMENT ROUTING BINDING SEGMENT IDENTIFIERS WITH PENULTIMATE SEGMENT POP

(71) Applicant: Juniper Networks, Inc., Sunnyvale, CA (US)

(72) Inventors: Abhishek CHAKRABORTY, Sunnyvale, CA (US); Vinayaka GUNTANAKKALA, Bengaluru (IN); Rajesh Shetty MANUR, Bengaluru (IN)

(21) Appl. No.: 19/466,728

(22) Filed: Feb. 2, 2026

(30) Foreign Application Priority Data
Feb. 3, 2025 (IN) 202541008681

(51) Int. Cl. H04L 45/00; H04L 45/74; H04L 69/22

(52) U.S. Cl. CPC H04L 45/34; H04L 45/74; H04L 69/22

(57) ABSTRACT

A network device may detect that a packet includes a segment routing header (SRH) as part of processing a segment routing over Internet protocol version 6 (SRv6) binding segment identifier (SID) endpoint behavior. The network device may determine that a segment left value associated with the SRH is zero during processing of the binding SID endpoint behavior, and may remove the SRH from the packet based on the segment left value being zero and utilizing a penultimate segment pop (PSP).

### CROSS-REFERENCE TO RELATED APPLICATION

This Patent Application claims priority to India Provisional Patent Application No. 202541008681, filed on Feb. 3, 2025, and entitled “SEGMENT ROUTING BINDING SEGMENT IDENTIFIERS WITH PENULTIMATE SEGMENT POP.” The disclosure of the prior Application is considered part of and is incorporated by reference into this Patent Application.

### BACKGROUND

Segment routing over Internet protocol (IP) version 6 (SRv6) is a routing protocol that leverages the IPv6 address space to implement segment routing. In SRv6, each segment is represented as an IPv6 address, known as a segment identifier (SID). SIDs may be used to steer packets through a pre-determined set of segments, such as network devices, links, or specific instructions. Path information may be encoded within packet headers, reducing the need for complex state maintenance at intermediate network devices.

### SUMMARY

Some implementations described herein relate to a method. The method may include detecting that a packet includes a segment routing header (SRH) as part of processing an SRv6binding SID endpoint behavior. The method may include determining that a segment left value associated with the SRH is zero during processing of the binding SID endpoint behavior. The method may include removing the SRH from the packet based on the segment left value being zero and utilizing a penultimate segment pop (PSP).

Some implementations described herein relate to a network device. The network device may include one or more memories and one or more processors. The one or more processors may be configured to detect that a packet includes an SRH as part of processing an SRv6 binding SID endpoint behavior. The one or more processors may be configured to determine that a segment left value associated with the SRH is zero during processing of the binding SID endpoint behavior. The one or more processors may be configured to remove the SRH from the packet based on the segment left value being zero and utilizing a PSP, and decrease an Internet protocol version 6 (IPv6) header payload length based on the segment left value being zero.

Some implementations described herein relate to a non-transitory computer-readable medium that stores a set of instructions. The set of instructions, when executed by one or more processors of a network device, may cause the network device to detect that a packet includes an SRH as part of processing an SRv6 binding SID endpoint behavior. The set of instructions, when executed by one or more processors of the network device, may cause the network device to determine that a segment left value associated with the SRH is zero during processing of the binding SID endpoint behavior, and remove the SRH from the packet based on the segment left value being zero and utilizing a PSP. The set of instructions, when executed by one or more processors of the network device, may cause the network device to update a next header field in a preceding header of the packet to a next header value from the SRH based on the segment left value being zero.

### BRIEF DESCRIPTION OF THE DRAWINGS

FIGS. 1A-1C are diagrams of an example associated with SRv6 binding SIDs with penultimate segment pop (PSP) (also known as post stack processing).

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for SRv6 binding SIDs with PSP.

### DETAILED DESCRIPTION

The following detailed description of example implementations refers to the accompanying drawings. The same reference numbers in different drawings may identify the same or similar elements.

“PSP” in the context of SRv6 refers to an action where a network device before a final destination in an SRv6 path removes a segment routing header (SRH) from a packet, effectively offloading processing from a final destination network device and improving forwarding efficiency. In SRv6 traffic engineering, a candidate path from an ingress provider edge (PE) network device may be constructed with paths containing SRv6 binding SIDs (BSIDs) of a transit network device. At transit, where the SRv6 binding SIDs are instantiated, the binding SID endpoint behavior may be processed and a new encapsulation or SRH may be added, depending on endpoint behavior identified in the binding SID endpoint behavior.

After processing the binding SID endpoint behavior, a destination address (DA) is updated to a next SID and a segment left identifier in the SRH becomes zero (0). However, the inner SRH cannot be removed after a binding SID without PSP is processed. Thus, even though the inner SRH has no utility, the inner SRH remains in the packet until the packet reaches a destination, thereby creating unnecessary SRH overhead. Thus, current techniques for SRv6 traffic engineering consume computing resources (e.g., processing resources, memory resources, communication resources, and/or the like), networking resources, and/or the like, associated with processing unnecessary SRH overhead in a packet, utilizing greater bandwidth for the unnecessary SRH overhead, creating network congestion and network churn based on utilizing the greater bandwidth, creating complex flows to process the unnecessary SRH overhead, and/or the like.

Some implementations described herein relate to providing SRv6 binding SIDs with PSP. For example, a network device may detect that a packet includes an SRH as part of processing an SRv6 binding SID endpoint behavior. The network device may determine that a segment left value associated with the SRH is zero during processing of the binding SID endpoint behavior, and may remove the SRH from the packet based on the segment left value being zero and utilizing a PSP.

In this way, the implementations provide SRv6 binding SIDs with PSP. For example, the implementations may provide PSP for all types of SRv6 binding SID endpoint behaviors. When PSP is configured, a transit network device may remove an inner SRH (e.g., when a segment left indicator is zero (0)) and may process the binding SID endpoint behavior. This will remove unnecessary SRH overhead at the transit network device, which will result in less network bandwidth consumption, better interoperability since the extra SRH is removed, and less complexity to handle traffic. Thus, the implementations conserve computing resources, networking resources, and/or the like that would otherwise have been consumed by processing unnecessary SRH overhead in a packet, utilizing greater bandwidth for the unnecessary SRH overhead, creating network congestion and network churn based on utilizing greater bandwidth, creating complex flows to process the unnecessary SRH overhead, and/or the like.

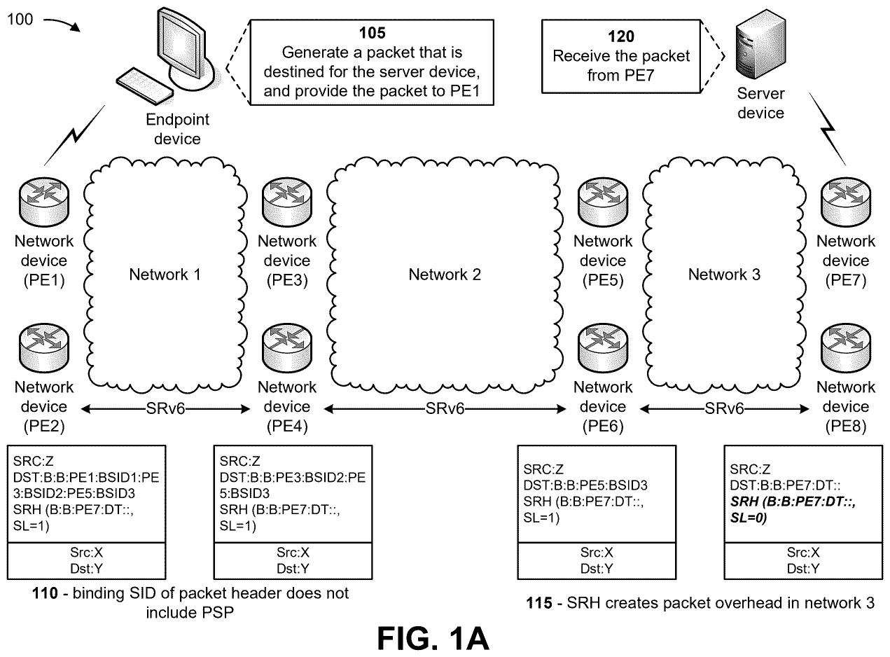

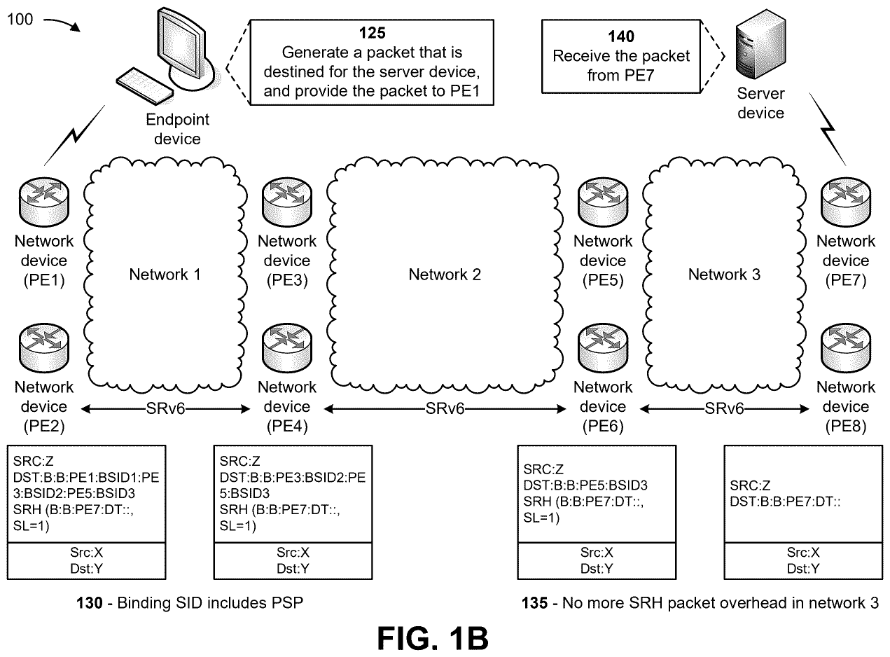

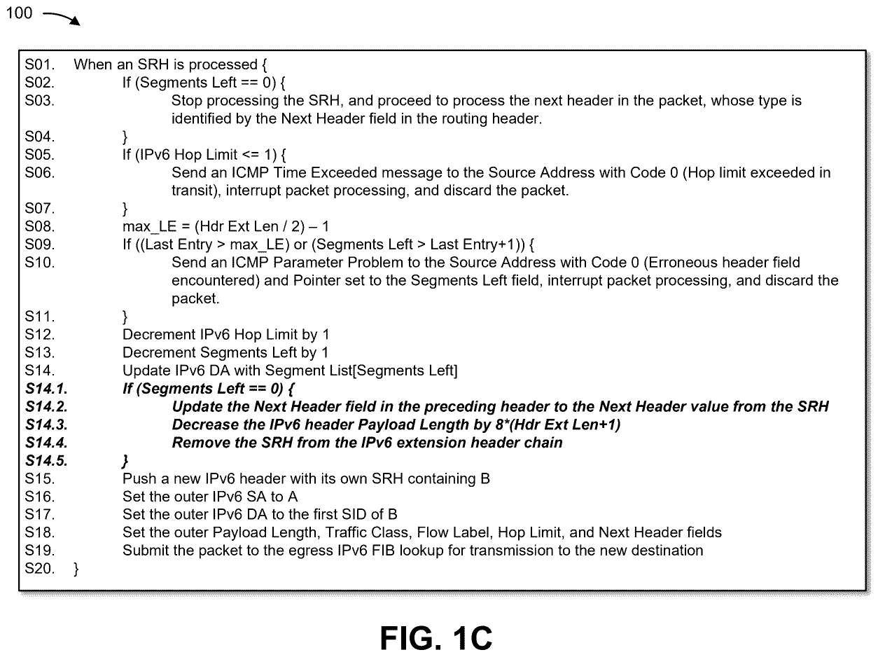

FIGS. 1A-1C are diagrams of an example 100 associated with providing SRv6 binding SIDs with PSP. As shown in FIGS. 1A-1C, the example 100 includes an endpoint device associated with three networks (e.g., a first network (network 1), a second network (network 2), and a third network (network 3)), and a server device. Each of the networks may utilize the SRv6 routing protocol, and may include multiple network devices. The multiple network devices may include a first PE (PE1) network device, a second PE (PE2) network device, a third PE (PE3) network device, a fourth PE (PE4) network device, a fifth PE (PE5) network device, a sixth PE (PE6) network device, a seventh PE (PE7) network device, and an eighth PE (PE8) network device. Further details of the endpoint device, the server device, the network, and the network devices are provided elsewhere herein.

As shown in FIG. 1A, and by reference number 105, the endpoint device may generate a packet that is destined for the server device, and may provide the packet to the PE1 network device. For example, the endpoint device may generate a packet that includes a packet header. The packet header at the PE1 network device may include a binding SID that results in adding one or more IPv6 encapsulations, such as a PE1 binding SID encapsulation, a PE3 binding SID encapsulation, a PE5 binding SID encapsulation, and an SRH binding SID encapsulation.

As further shown in FIG. 1A, and by reference number 110, the binding SID endpoint behavior of the packet header at the PE1 network device may not include PSP. For example, the binding SID endpoint behavior used in the packet header for binding purposes does not contain a PSP function or flag. Therefore, since the binding SID endpoint behavior does not include PSP, the packet will not have the PSP behavior applied (i.e., the SRH binding SID encapsulation will not be popped by the penultimate network device, and the last network device in the packet path will process the SID as usual).

The PE1 network device may provide the packet to the PE3 network device via the first network. The PE3 network device may receive the packet via the first network, and may remove the PE1 binding SID encapsulation from the packet. The PE3 network device may provide the packet to the PE5 network device via the second network. The PE5 network device may receive the packet via the second network, and may remove the PE3 binding SID encapsulation from the packet. The PE5 network device may be the penultimate network device for the packet.

As further shown in FIG. 1A, and by reference number 115, the SRH binding SID encapsulation of the packet header may create packet overhead through the third network. For example, the PE5 network device may provide the packet to the PE7 network via the third network. The SRH binding SID encapsulation may be removed at the PE5 network device, but is not, since PSP is not provided. Thus, the SRH binding SID encapsulation in the packet header creates packet overhead as the packet is routed through the third network to the PE7 network device (e.g., the last network device). The PE7 network device may receive the packet via the third network, and may remove the PE5 binding SID encapsulation from the packet.

As further shown in FIG. 1A, and by reference number 120, the server device may receive the packet from the PE7 network device. For example, the PE7 network device may provide the packet to the server device, and the server device may receive the packet. The server device may utilize the packet to perform one or more functions associated with the packet and requested by the endpoint device (e.g., execute an application, provide data, and/or the like).

As shown in FIG. 1B, and by reference number 125, the endpoint device may generate a packet that is destined for the server device, and may provide the packet to the PE1 network device. For example, the endpoint device may generate a packet that includes a packet header. The packet header at the PE1 network device may include a binding SID that results in adding one or more IPv6 encapsulations, such as a PE1 binding SID encapsulation, a PE3 binding SID encapsulation, a PE5 binding SID encapsulation, and an SRH binding SID encapsulation. In some implementations, new endpoint behaviors may be introduced for the SRv6 binding SID, such as, for example, END.B6.Encaps, PSP; END.B6.Encaps. Red, PSP; END.B6.Encaps with Next-C-SID, PSP; END.B6.Encaps. Red with Next-C-SID, PSP; END.BM, PSP; END.BM with Next-C-SID, PSP; and/or the like.

As further shown in FIG. 1B, and by reference number 130, the binding SID endpoint behavior of the packet header at the PE1 network device may include PSP. For example, the binding SID endpoint behavior used in the packet header for binding purposes contains a PSP function or flag (e.g., an example of which is described below in connection with FIG. 1C). Therefore, since the binding SID endpoint behavior includes PSP, the packet will have the PSP behavior applied (i.e., the SRH binding SID encapsulation will be popped by the penultimate network device and will not cause packet overhead).

The PE1 network device may provide the packet to the PE3 network device via the first network. The PE3 network device may receive the packet via the first network, and may remove the PE1 binding SID encapsulation from the packet. The PE3 network device may provide the packet to the PE5 network device via the second network. The PE5 network device may receive the packet via the second network, and may remove the PE3 binding SID encapsulation from the packet. The PE5 network device may be the penultimate network device for the packet.

As further shown in FIG. 1B, and by reference number 135, the SRH binding SID encapsulation of the packet header may not create packet overhead through the third network. For example, the PE5 network device may provide the packet to the PE7 network via the third network. The SRH binding SID encapsulation may be removed at the PE5 network device since PSP is provided. Thus, no packet overhead is provided by the packet header as the packet is routed through the third network to the PE7 network device (e.g., the last network device). The PE7 network device may receive the packet via the third network, and may remove the PE5 binding SID encapsulation from the packet.

As further shown in FIG. 1B, and by reference number 140, the server device may receive the packet from the PE7 network device. For example, the PE7 network device may provide the packet to the server device, and the server device may receive the packet. The server device may utilize the packet to perform one or more functions associated with the packet and requested by the endpoint device (e.g., execute an application, provide data, and/or the like).

FIG. 1C provides example instructions that may be executed by a network device bound to an SRv6 policy with encapsulation. The example instructions may be modified so that SRH processing, of SRv6 binding SID endpoint behaviors, is modified. For example, after the instruction “S14. Update IPv6 DA with Segment List[Segments Left]” is executed, the following instructions may be executed as well:
S14.1. If (Segments Left==0){
S14.2. Update the Next Header field in the preceding header to the Next Header value from the SRH
S14.3. Decrease the IPv6 header Payload Length by 8*(Hdr Ext Len+1)
S14.4. Remove the SRH from the IPv6 extension header chain
S14.5.}.
   These instructions may cause the penultimate network device (e.g., the PE5 network device) to remove the SRH from the IPv6 extension header chain since the segments left will be zero at the penultimate network device. Removal of the SRH may prevent unnecessary overhead for a packet traversing the third network.

In this way, the implementations provide SRv6 binding SIDs with PSP. For example, the implementations may provide PSP for all types of SRv6 binding SID endpoint behaviors. When PSP is configured, a transit network device may remove an inner SRH (e.g., when a segment left indicator is zero (0)) and may process the binding SID endpoint behavior. This will remove unnecessary SRH overhead at the transit network device, which will result in less network bandwidth consumption, better interoperability since the extra SRH is removed, and less complexity to handle traffic. Thus, the implementations conserve computing resources, networking resources, and/or the like that would otherwise have been consumed by processing unnecessary SRH overhead in a packet, utilizing greater bandwidth for the unnecessary SRH overhead, creating network congestion and network churn based on utilizing greater bandwidth, creating complex flows to process the unnecessary SRH overhead, and/or the like.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

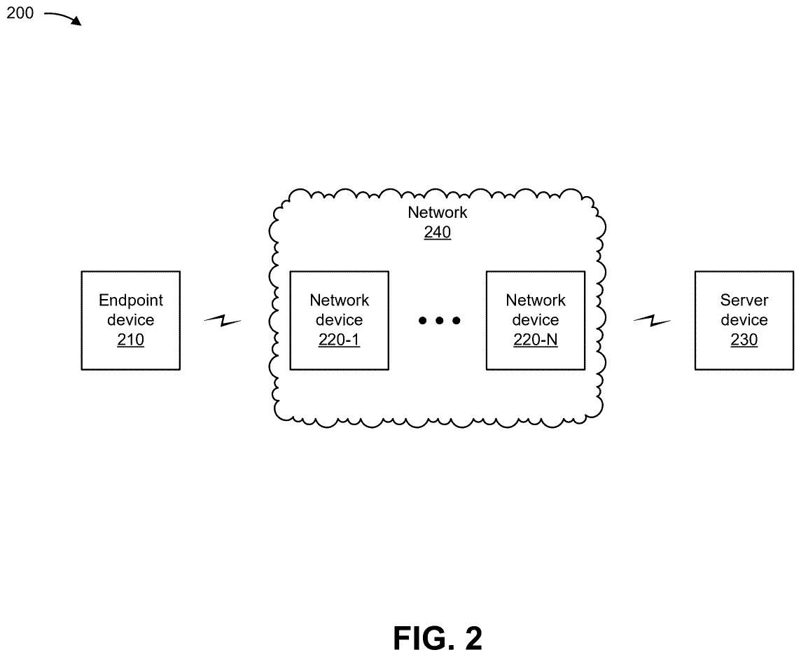

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a server device 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the server device 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The server device 230 may include one or more devices capable of receiving, generating, storing, processing, providing, and/or routing information, as described elsewhere herein. The server device 230 may include a communication device and/or a computing device. For example, the server device 230 may include a server, such as an application server, a client server, a web server, a database server, a host server, a proxy server, a virtual server (e.g., executing on computing hardware), or a server in a cloud computing system. In some implementations, the server device 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, and/or a code division multiple access (CDMA) network), a public land mobile network (PLMN), a local area network (LAN), a WAN, a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

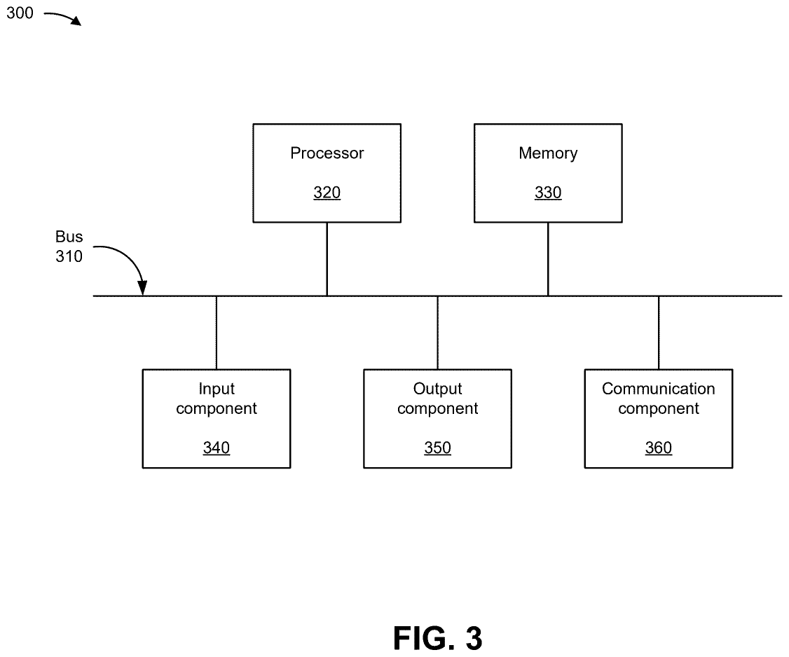

FIG. 3 is a diagram of example components of one or more devices of FIG. 2. The example components may be included in a device 300, which may correspond to the endpoint device 210, the network device 220, and/or the server device 230. In some implementations, the endpoint device 210, the network device 220, and/or the server device 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

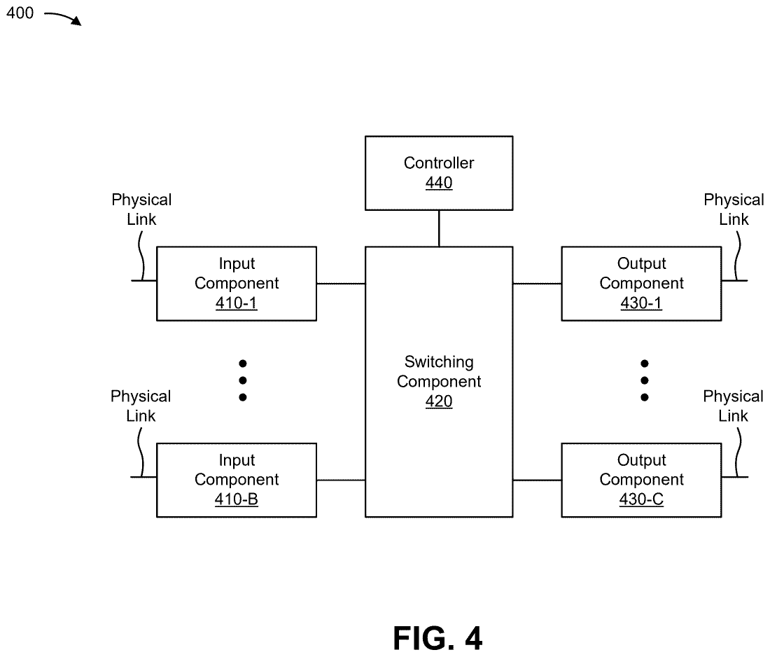

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication component. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

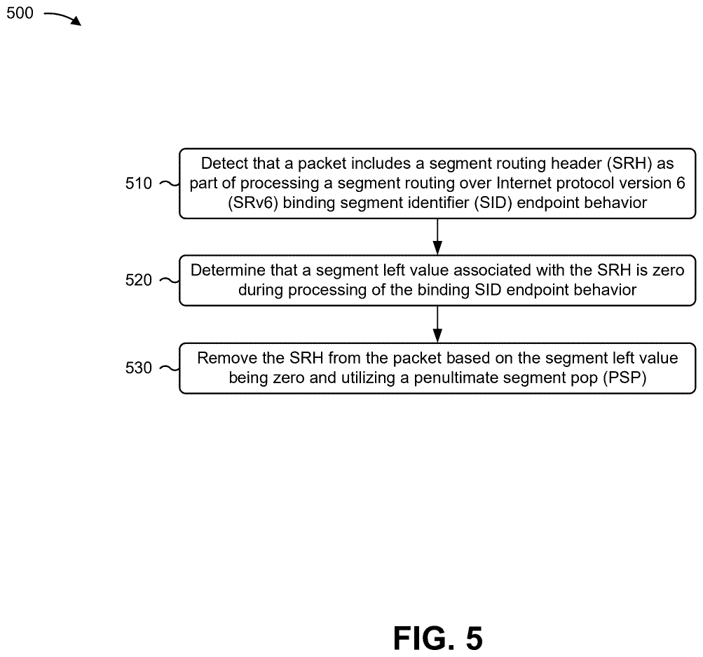

FIG. 5 is a flowchart of an example process 500 for SRv6 binding SIDs with PSP. In some implementations, one or more process blocks of FIG. 5 may be performed by a network device (e.g., the network device 220). In some implementations, one or more process blocks of FIG. 5 may be performed by another device or a group of devices separate from or including the network device, such as an endpoint device (e.g., the endpoint device 210) and/or a server device (e.g., the server device 230). Additionally, or alternatively, one or more process blocks of FIG. 5 may be performed by one or more components of the device 300, such as the processor 320, the memory 330, the input component 340, the output component 350, and/or the communication component 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include detecting that a packet includes an SRH as part of processing an SRv6 binding SID endpoint behavior (block 510). For example, the network device may detect that a packet includes an SRH as part of processing an SRv6 binding SID endpoint behavior, as described above. In some implementations, the binding SID endpoint behavior is the PSP. In some implementations, the binding SID endpoint behavior is selected from a plurality of binding SID endpoint behaviors. In some implementations, the network device is a penultimate network device for routing the packet.

As further shown in FIG. 5, process 500 may include determining that a segment left value associated with the SRH is zero during processing of the binding SID endpoint behavior (block 520). For example, the network device may determine that a segment left value associated with the SRH is zero during processing of the binding SID endpoint behavior, as described above.

As further shown in FIG. 5, process 500 may include removing the SRH from the packet based on the segment left value being zero and utilizing a PSP (block 530). For example, the network device may remove the SRH from the packet based on the segment left value being zero and utilizing a PSP, as described above. In some implementations, removing the SRH from the packet reduces bandwidth consumption in a network associated with the network device.

In some implementations, process 500 includes updating a next header field in a preceding header of the packet to a next header value from the SRH based on the segment left value being zero. In some implementations, process 500 includes decreasing an IPv6 header payload length based on the segment left value being zero. In some implementations, process 500 includes removing the SRH from an IPv6 extension header chain based on the segment left value being zero.

In some implementations, process 500 includes processing the binding SID endpoint behavior according to an encapsulation behavior prior to removing the SRH from the packet. In some implementations, process 500 includes adding an Internet protocol version 6 (IPv6) encapsulation header prior to subsequent processing of the binding SID endpoint behavior. In some implementations, process 500 includes providing the packet to another network device after removing the SRH from the packet. In some implementations, the other network device is a final network device for routing the packet. In some implementations, the other network device is configured to process the packet without the SRH.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
detecting, by a network device, that a packet includes a segment routing header (SRH) as part of processing a segment routing over Internet protocol version 6 (SRv6) binding segment identifier (SID) endpoint behavior;
determining, by the network device, that a segment left value associated with the SRH is zero during processing of the binding SID endpoint behavior; and
removing, by the network device, the SRH from the packet based on the segment left value being zero and utilizing a penultimate segment pop (PSP).

2. The method of claim 1, further comprising:
updating a next header field in a preceding header of the packet to a next header value from the SRH based on the segment left value being zero.

3. The method of claim 1, further comprising:
decreasing an Internet protocol version 6 (IPv6) header payload length based on the segment left value being zero.

4. The method of claim 1, further comprising:
removing the SRH from an Internet protocol version 6 (IPv6) extension header chain based on the segment left value being zero.

5. The method of claim 1, wherein the binding SID endpoint behavior is the PSP.

6. The method of claim 1, wherein the binding SID endpoint behavior is selected from a plurality of binding SID endpoint behaviors.

7. The method of claim 1, further comprising:
processing the binding SID endpoint behavior according to an encapsulation behavior prior to removing the SRH from the packet.

8. A network device, comprising:
one or more memories; and
one or more processors to:
detect that a packet includes a segment routing header (SRH) as part of processing a segment routing over Internet protocol version 6 (SRv6) binding segment identifier (SID) endpoint behavior;
determine that a segment left value associated with the SRH is zero during processing of the binding SID endpoint behavior;
remove the SRH from the packet based on the segment left value being zero and utilizing a penultimate segment pop (PSP); and
decrease an Internet protocol version 6 (IPv6) header payload length based on the segment left value being zero.

9. The network device of claim 8, wherein the one or more processors are further to:
add an Internet protocol version 6 (IPv6) encapsulation header prior to subsequent processing of the binding SID endpoint behavior.

10. The network device of claim 8, wherein removing the SRH from the packet reduces bandwidth consumption in a network associated with the network device.

11. The network device of claim 8, wherein the network device is a penultimate network device for routing the packet.

12. The network device of claim 8, wherein the one or more processors are further to:
provide the packet to another network device after removing the SRH from the packet.

13. The network device of claim 12 wherein the other network device is a final network device for routing the packet.

14. The network device of claim 12, wherein the other network device is configured to process the packet without the SRH.

15. A non-transitory computer-readable medium storing a set of instructions, the set of instructions comprising:
one or more instructions that, when executed by one or more processors of a network device, cause the network device to:
detect that a packet includes a segment routing header (SRH) as part of processing a segment routing over Internet protocol version 6 (SRv6) binding segment identifier (SID) endpoint behavior;
determine that a segment left value associated with the SRH is zero during processing of the binding SID endpoint behavior;
remove the SRH from the packet based on the segment left value being zero and utilizing a penultimate segment pop (PSP); and
update a next header field in a preceding header of the packet to a next header value from the SRH based on the segment left value being zero.

16. The non-transitory computer-readable medium of claim 15, wherein the one or more instructions further cause the network device to:
decrease an Internet protocol version 6 (IPv6) header payload length based on the segment left value being zero.

17. The non-transitory computer-readable medium of claim 15, wherein the one or more instructions further cause the network device to:
remove the SRH from an Internet protocol version 6 (IPv6) extension header chain based on the segment left value being zero.

18. The non-transitory computer-readable medium of claim 15, wherein the one or more instructions further cause the network device to:
process the binding SID endpoint behavior according to an encapsulation behavior prior to removing the SRH from the packet.

19. The non-transitory computer-readable medium of claim 15, wherein the one or more instructions further cause the network device to:
add an Internet protocol version 6 (IPv6) encapsulation header prior to subsequent processing of the binding SID endpoint behavior.

20. The non-transitory computer-readable medium of claim 15, wherein the one or more instructions further cause the network device to:
provide the packet to another network device after removing the SRH from the packet.
